(19) United States
(12) Patent Application Publication
(10) Pub. No.: US 2015/0019341 A1
(43) Pub. Date: Jan. 15, 2015

(54) SYSTEM AND METHOD FOR DISPLAYING INFORMATION ON MOBILE DEVICES

(71) Applicant: Kiosked Oy Ab, Espoo (FI)

(72) Inventors: Antti Pasila, Helsinki (FI); Lars-Michael Paqvalén, Espoo (FI); Katarina Tallberg, Helsinki (FI); Charlotta Turku, Skuru (FI)

(73) Assignee: Kiosked Oy Ab, Espoo (FI)

(21) Appl. No.: 14/262,838

(22) Filed: Apr. 28, 2014

Related U.S. Application Data
(60) Provisional application No. 61/817,021, filed on Apr. 29, 2013.

(51) Int. Cl. G06Q 30/06; G06Q 30/02; H04L 29/08; G06F 3/0481; G06F 3/0484

(52) U.S. Cl. CPC G06Q 30/0643; G06F 3/0481; G06F 3/04845; H04L 67/10; G06Q 30/0267
USPC 705/14.64

(57) ABSTRACT

A system and method for displaying information on mobile devices via a user interface (UI) includes an overlay structure on top of an application or web page which shows content related to a product or service. The overlay structure on top of an application or web page showing content related to the promoted product enables user action such as purchasing the product or service without taking the user away from the original view used for accessing the information.

This application claims the benefit of U.S. Provisional Application 61/817,021 filed 29 Apr. 2013.

### FIELD

The disclosed embodiments generally relate to a system and method for displaying information on mobile devices, and more specifically to a user interface (UI) for presenting information on the mobile devices. Further, aspects of the disclosure are also directed to mobile shopping and advertisements.

### BACKGROUND

The increased penetration of Internet enabled electronic devices such as non-portable terminals, portable terminals, smartphones and tablets is causing a significant shift in the traditional terminals of advertisement. Shopping and advertising have been a big topic in the Internet industry and growing at a very fast pace. An estimate suggests that worldwide mobile advertising revenue is set to reach $11.4 billion in 2013, up from $9.6 billion in 2012. There are many different forms of advertisement delivery methods that include delivery of advertisements along with web pages, games, applications, web applications, and software. Internet based businesses rely on advertisements to promote their business according to their marketing plans. Advertisements play an important role in generating revenue for mobile content and software developers.

Conventionally, advertisements appear on websites, games, software application, video or other media, such as content displayed in browsers on various devices. The advertisements themselves are selected based on the content displayed to the user and served by automated systems, for example, in new browser windows, in page formats, or in pop-ups which take the user to a web browser. The problem with prior art methods of presenting advertisements is that the user is directed away from the application, web page or activity when the user accesses the advertisement to pursue it further, make a purchase, or explore more about the advertisement. In the case of pop up advertisements for mobile applications, clicking an ad directs the user to a web page. This leads to user dissatisfaction and may lead to negative action related to the promoted content or product. This is undesirable for a software or content developer showing the advertisement as the users are driven away from it by selecting an advertisement which reduces the time spent on their content. In case of mobile gaming this becomes a real issue because users are dropped in middle of a game leading to a negative experience towards the game. Also, because mobile phones have limited viewing space due to small screen size and screen resolution, a user cannot access a single complete webpage view and this limits space available for the advertisements.

Hence, there exists a need for a system and user interface that facilitates user exploration of advertisements or information during an activity on webpage or application without affecting it, that solves the problem of viewing advertisements or making purchases during engaging activities such as gaming, that avoids reducing time spent on an application or reducing interest due to distraction caused by opening a new browser window, and that overcomes the above-mentioned limitations of existing methods of displaying information on various devices, for example, mobile devices.

### SUMMARY

The disclosed embodiments provide a system and method for displaying information on a terminal.

In one aspect, embodiments of the present disclosure provide a system for displaying information via a user interface (UI) that has an overlay structure on top of an application or web page which shows content related to a product or service such as advertisements.

In another aspect, the disclosed embodiments are directed to a method of displaying information on a device including showing at least a first content item on a display, upon selecting the first content item, providing an overlay of information over the display, and providing a scrolling function as part of the overlay for displaying additional information.

The disclosed embodiments include an apparatus for displaying information comprising a processor, and a memory comprising program code, wherein the processor under control of the program code causes the apparatus to show at least a first content item on a display, upon selection of the first content item, provide an overlay of information over the display, and provide a scrolling function as part of the overlay for displaying additional information.

In another aspect of the disclosed embodiments, a non-transitory computer-readable medium having computer-executable components includes instructions for showing at least a first content item on a display, upon selecting the first content item, providing an overlay of information over the display, and providing a scrolling function as part of the overlay for displaying additional information.

In accordance with an embodiment of the present disclosure, the content can include means for purchasing the product or service, lead information to the merchant or provide information to a user without leaving a view on which the promoted content has been selected.

In accordance with another embodiment of the present disclosure, the system includes logic on the overlay structure. X-axis i.e. movements in a horizontal direction can include information related to the product such as product images, descriptions and webstore access. Y-axis i.e. movements in vertical direction can include additional products.

In accordance with yet another embodiment of the present disclosure, the user interface includes overlay areas that can have elements such as links, maps, videos, images, text, elements and can be interactive.

In accordance with yet another embodiment of the present disclosure, the user interface (UI) may be implemented by using one or more touch-sensitive graphical display wireless devices. The display of the wireless devices employed to implement the user interface (UI) are connected to the Internet. Typical examples of the wireless devices include, although are not limited to, smart phones, Mobile Internet Devices (MID), wireless-enabled tablet computers, Ultra-Mobile Personal Computers (UMPC), phablets, tablet computers, Personal Digital Assistants (PDA), web pads, and cellular phones.

In another aspect, embodiments of the present disclosure provide a method for displaying information on mobile terminals.

Embodiments of the present disclosure facilitate displaying overlays in the screen using a user interface (UI) which shows content related to a promoted product and enable purchasing a product or service without leaving a view. The overlay layout of the UI may provide X-axis movements, i.e. movements in a horizontal direction which may include information related to the product such as product images, descriptions and webstore access and Y-axis movements, i.e. movements in a in vertical direction which may include additional products. This improves space availability for an advertisement which was previously limited by the screen size or resolution.

In accordance with yet another embodiment of the present disclosure, the user interface (UI) can be used for immediate purchasing using a “one click” approach and may include actions related to inserting credit card numbers or logging/authenticating to some web store or merchant system. The web store can be opened in a separate browser view or the overlay can be extended to cover substantially an entire screen to present content of the web store for the user. The benefit of using the UI is that the user may go back to the originating web page or application without affecting their situation after the actions with the overlays are done.

Additional aspects, advantages, features and objects of the present disclosure would be made apparent from the drawings and the detailed description of the illustrative embodiments.

It will be appreciated that features of the disclosed embodiments are susceptible to being combined in various combinations or further improvements without departing from the scope of the disclosed embodiments and the present application.

### BRIEF DESCRIPTION OF THE FIGURES

The summary above, as well as the following detailed description of illustrative embodiments, is better understood when read in conjunction with the appended drawings. For the purpose of illustrating the present disclosure, exemplary constructions of the disclosure are shown in the drawings. However, the disclosed embodiments are not limited to specific methods and instrumentalities disclosed herein. Moreover, it should be understood that the drawings are not to scale. Wherever possible, like elements have been indicated by identical numbers.

FIG. 1 shows example view of a screen of a mobile terminal.

FIG. 2 illustrates example of interaction in the overlays in the screen.

FIG. 3 presents logic on the overlay structure.

FIG. 4 presents an example of interaction in the user interface (UI) overlays in full screen.

FIG. 5A, 5B, and 5C illustrates the user interface (UI) overlays in accelerometer enabled devices.

FIG. 6 illustrates an example of the user interface (UI) overlays on a web enabled wireless device in portrait mode during shopping.

FIG. 7 illustrates an example of the user interface (UI) overlays on a web enabled wireless device in landscape mode during shopping.

FIG. 8A, 8B, 9A, and 9B are additional exemplary views of a screen while using the user interface (UI) for finding additional information.

FIG. 10 shows a block diagram of a computing apparatus 1000 that may be used to practice aspects of the disclosed embodiment.

### DETAILED DESCRIPTION

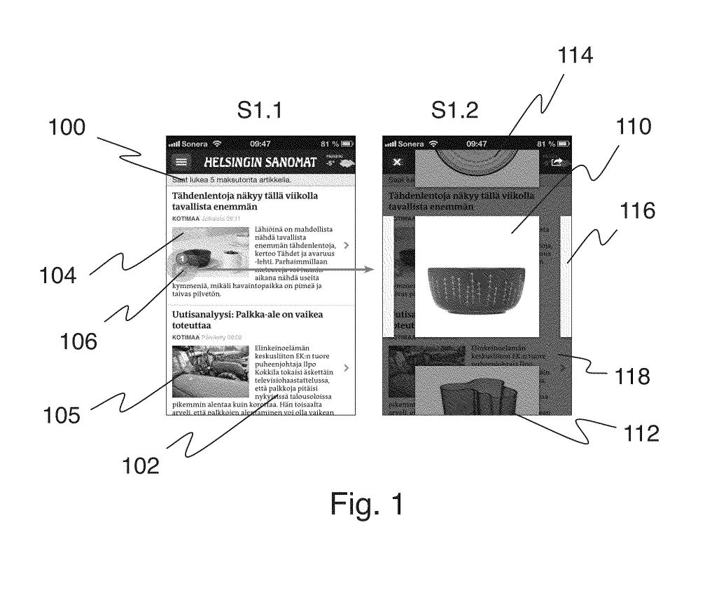

Referring now to the drawings, particularly by their reference numbers, FIG. 1 shows an example view of a screen of a mobile terminal (for example, an iPhone® of Apple). In step S1.1. the user may use a web browser to access web page 100. Content can include digital content such as images, videos, text etc. In the example there is a web page of a newspaper with images 104 and 105 and some text 102. The page can be technically implemented using, for example, HTML5, HTML, or other technologies used in the implementation of web based applications. The page can include scripts of java etc. According to the disclosed embodiments, image 104 includes an indicator 106 in the corner of the image that said image might include additional information.

In step S1.2 the user clicks/points/touches with a finger or a touch simulating device, or otherwise selects, the indicator 106. The gesture of selecting the indicator, for example by touching, initiates an overlay picture on top of the web content. In at least one embodiment the overlay structure may be organized as set of rectangular areas of 110, 112, 114. The area 110 in the middle shows details of the product which was in the image 104. The content of the area 110 can be arbitrary but in at least one embodiment the content is related to the image. The areas 112 and 114 below and on top of the area 110 respectively have details of other products related to the image 104 or to the content of area 110. There are areas 116 on the left and right side of the middle area 110. The web page 100 is shown as a dimmed version 118 behind the overlay.

According to the disclosed embodiments, information content for the overlay may be downloaded from a web service at the time a user touches the indicator 106 or it can be preloaded to the terminal at substantially the same time as the web content for the web page. An example means for acceding the content can be found from commonly assigned U.S. patent application Ser. No. 13/005,403 (published as U.S. 2012/179541), incorporated by reference herein. The overlay areas can have elements such as links, maps, videos, images, and text, and the elements can be interactive.

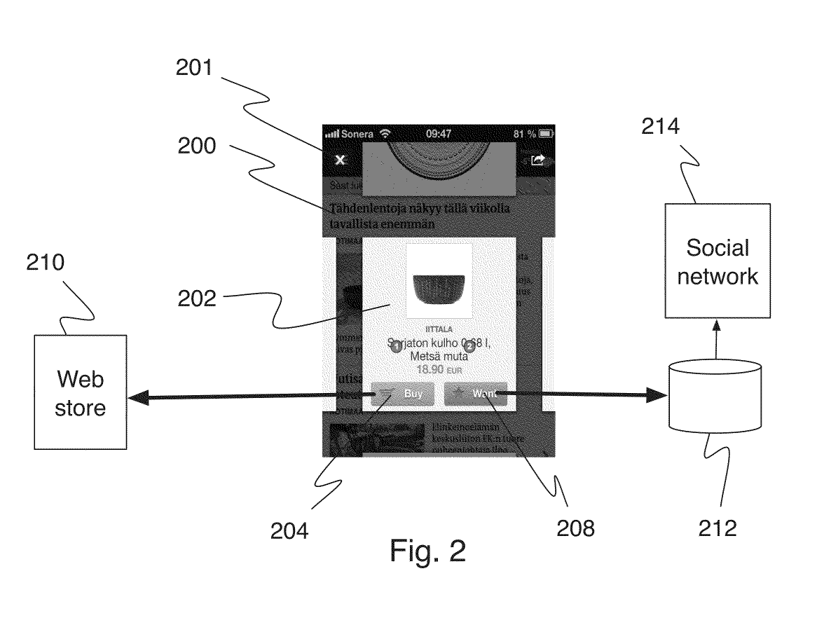

FIG. 2 shows an example of interaction in the user interface (UI) overlays on the screen 200. The middle area 202 includes image, text and other information such as pricing related to a product. The overlay area has button 204 for adding the item to a shopping cart for purchase, for example, from a web store 210. Purchasing can be done immediately using a “one click” approach, i.e. a mobile terminal would have credentials to complete purchases or the purchasing can include actions related to inserting credit card numbers or logging/authenticating to some web store or merchant system. The web store can be opened in a separate browser view or the overlay can be extended to cover substantially the entire screen to present content of the web store for the user. At least one benefit of using the overlay is providing a user with the ability to go back to the originating web page 100 after the actions with overlays are done. Button “x” 201 in the UI can be used to go back to the original web site or application, and for example, to close the overlay.

There can be other buttons such as “Want” button 208 in the area 202. Example usage would include storing a number of “Wants” for each product in a database 212. The information could be further shared through social networks 214 such as Facebook®, for example, by providing a status update in Facebook® : “User Hirvi.K wants to get Iittala” with a link so others might access the same item as well. Additionally there could be buttons such as “Share” instead or addition to “Want button 208 to share content or link to content of the overlay and/or underlying application or web site in social networks.

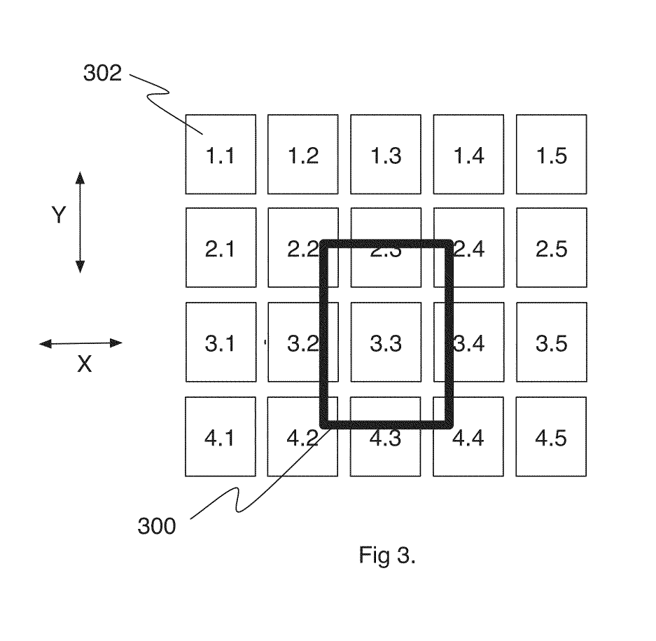

FIG. 3 shows an illustration of logic on the overlay structure of the user interface. X-axis i.e. movements such as scrolling in the horizontal direction can include information related to the product such as product images, descriptions and webstore access. Y-axis i.e. movements such as scrolling in the vertical direction can include additional products.

In at least one example there are areas 302 as marked with 1.1, 1.2, 1.3, 1.4, and 1.5 through 4.5. The user view 300 is shown in the FIG. 3. The current view would show area 3.3 and part of areas 3.2 and 3.4 on left and right of area 3.3. Areas 3.2 and 3.4 would include information related to the product shown in area 3.3. A user can scroll to the left and right, for example by swiping with a finger. As another example, when swiping a finger to the left, the area 3.4 would be in the middle and area 3.3 and 3.5 would be shown partially to the left and right of area 3.4. If user further swipes a finger to the left area 3.5 would be shown in the middle and part of area 3.4 would be to the left and part of the area 3.1 would be to the right as the selection information would scroll over, or wrap around.

In at least one embodiment, the areas on top and below the scrolled areas would not move as the areas are scrolled from left to right or right to left. In the example of swiping row 3 left and right described above, part of area 2.3 and part of area 4.3 would be shown and not moved. If a user scrolls downward, for example by swiping, the area 2.3 would be presented in the user view. The area 2.3 would be in the middle and areas 2.2 and 2.4 would be shown partially on the left and right of area 2.3. Area 1.3 and 3.3 would be shown partially on top and below of the area 2.3 respectively. If a user further swipes downward, the area 1.3 would be shown and area 4.3 would be shown partially on top of area 1.3 and area 2.3 would be shown partially below area 1.3. FIG. 3 may be implemented, for example, on a web page. The embodiments of the user interface can be applied also to an application domain i.e. on top of an application. In certain embodiments the overlay areas in the corners can be made invisible for a user (i.e. for example when 3.3 is a middle area, no content or frame of content may be shown for areas 2.2, 2.4, 4.2 and 4.4).

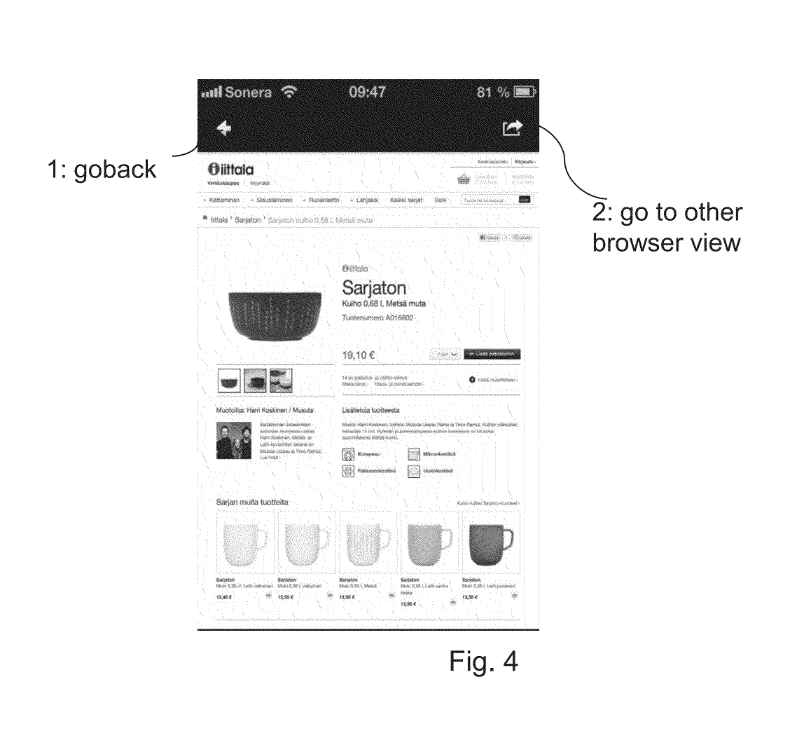

FIG. 4 shows an example of interaction in the user interface (UI) overlays in full screen mode. The overlay may be extended to cover substantially an entire screen to present content of the web store to a user. At least one benefit of using the overlay is providing the user with the possibility to go back to the originating web page 100 after the actions with the overlays are done. Button “1:goback” can be used for seeing previous overlays or exiting the overlays and button “2: go to other browser view” can be used to open the web store in a separate browser view. This provides a user with the flexibility of using the overlays and web browser for viewing the advertisement or the information.

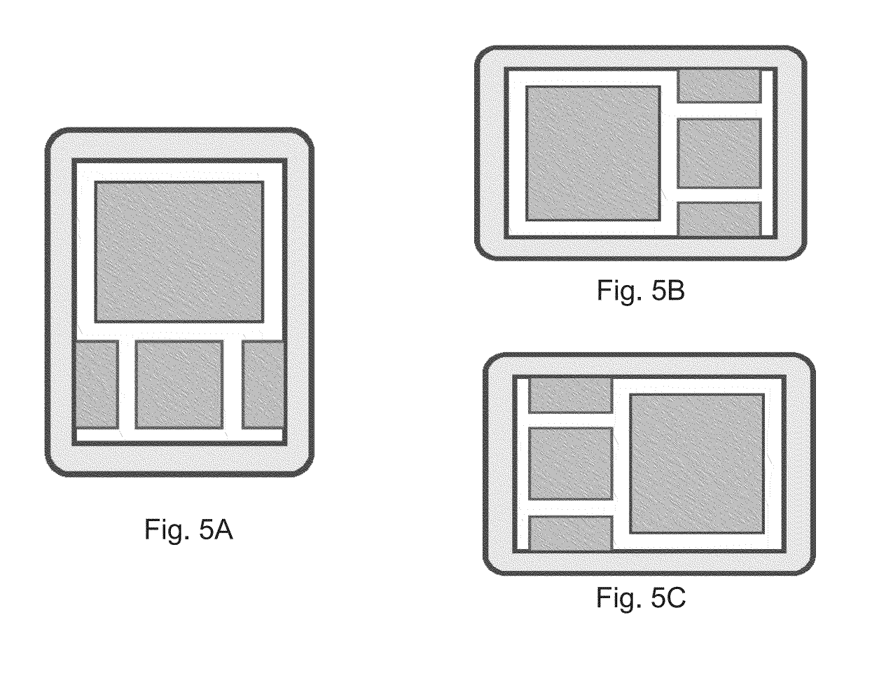

FIG. 5A, 5B, and 5C are illustrations of the user interface (UI) overlays for use in accelerometer enabled devices (for example, an iPad®) which may have different viewing modes based on device orientation. The user interface UI overlays may generally adapt to the orientation. FIG. 5A illustrates an exemplary portrait layout mode of the device. In this example, during a shopping related activity, product information may always be on top and a carousel of products may be positioned below. FIG. 5B illustrates an exemplary landscape layout of the device turned 90° counter clockwise. FIG. 5C illustrates an exemplary landscape layout of the device turned 90° clockwise. In the landscape layout the positions of the product information and the carousel of products may depend on the direction in which the user has turned the device.

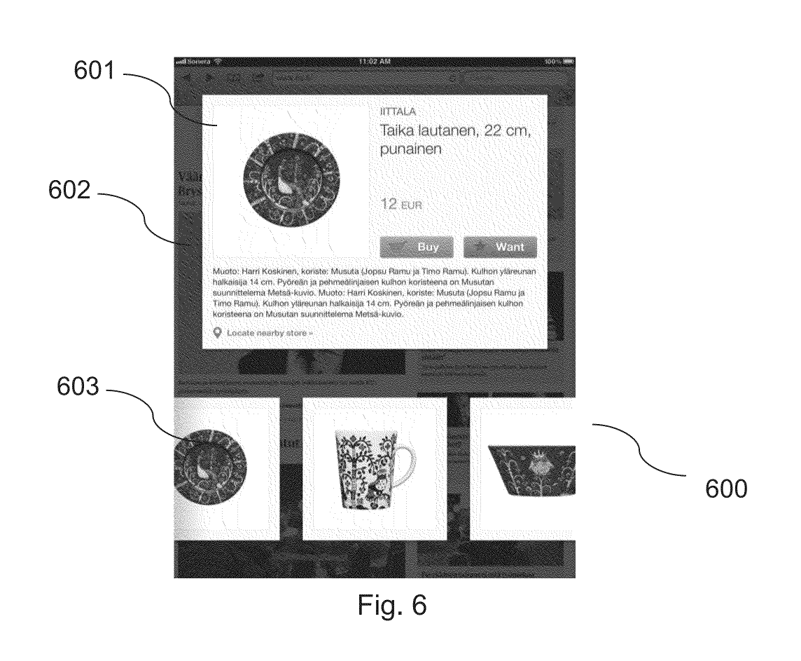

FIG. 6 shows an example of the user interface (UI) overlays on a web enabled wireless device (for example, an iPad®) in portrait mode during shopping. In the original view of the webpage on the device 600, tapping a corner of an image opens a second layer 601 and 603, covering the screen with a semi-transparent black layer 602. The product or products tagged in the image of the original view 600 appear highlighted in the overlay 601. The overlay shows key information about the “active” product such as product image, brand name, product name, price, and product description, and includes action buttons such as Buy Now. Item 603 is shown just below the “active” product and the other products tagged in the images from the original webpage 600 are shown as a continuously scrollable list. The user interface (UI) overlays follow the layout shown in FIG. 5A such that the product information is shown on the upper part of the screen and product images are displayed in a horizontally scrollable list on the lower part of the screen. Tapping on an image in the list 603 will open the relevant details for that particular product in the product information area 601. These are some of many examples that can be used to describe the system and should not unduly limit the scope of the embodiments of the present application disclosed herein. One of ordinary skill in the art would recognize many variations, alternatives, and modifications of the embodiments disclosed herein.

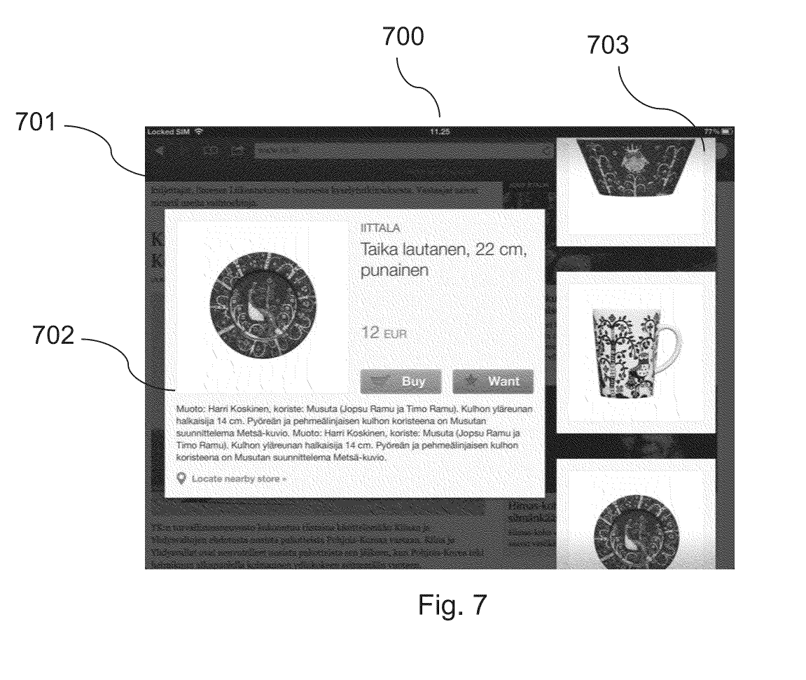

FIG. 7 shows an example of the user interface (UI) overlays on a web enabled wireless device (for example, an iPad®) in landscape mode during shopping. In the original view of the webpage on the device 700, tapping a corner of an image opens a second layer 702 and 703, covering the screen with a semi-transparent black layer 701. The product products tagged in the image of the original view 700 appear highlighted in the overlay 702. The overlay shows key information about the “active” product such as product image, brand name, product name, price, product description, and includes action buttons such as Buy Now. Item 703 is shown just below the “active” product and the other products tagged in the images from the original webpage 700 are shown as a continuously scrollable list. The user interface (UI) overlays follow the layout shown in FIG. 5B or 5C such that the product information is shown on one side 702 and the list of products 703 are shown next to the product information. Tapping on an image in the list 703 will open the relevant details for that particular product in the product information area 702. The placements of the items may be the same as for the portrait mode in FIG. 6, while the content within the containers may be rotated as the device turns. This enables a user to seamlessly view the content in different viewing modes of the device and provides a consistent feel of the user interface. These are some of many examples that can be used to describe the system and this should not unduly limit the scope of the embodiments of the present application disclosed herein. One of ordinary skill in the art would recognize many variations, alternatives, and modifications of the disclosed embodiments.

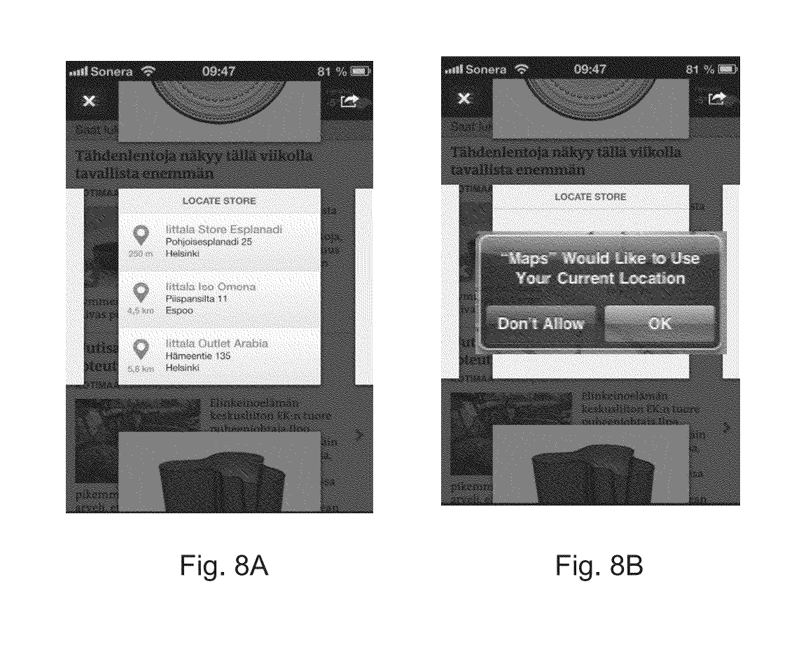

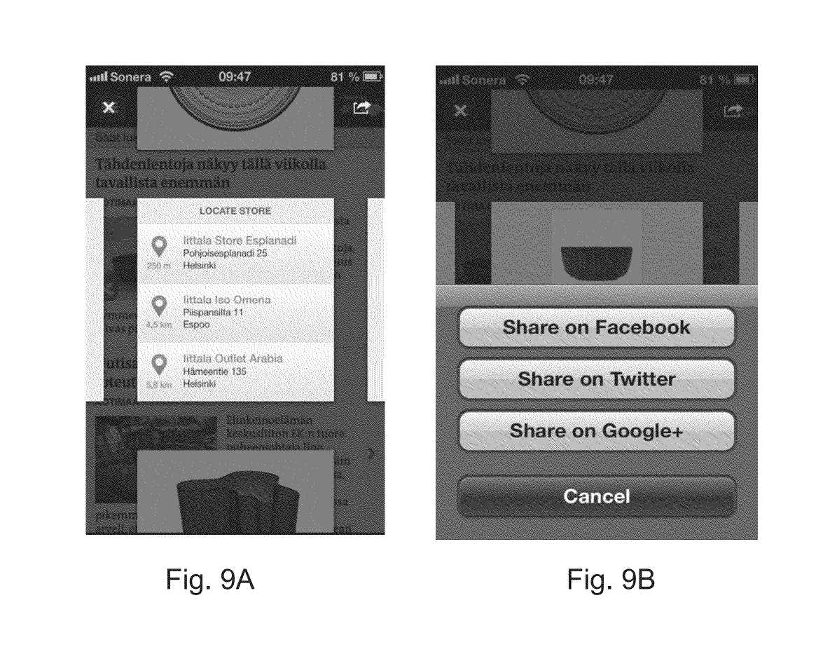

FIG. 8A, 8B, 9A, and 9B are additional example views of screens provided while using the user interface (UI) for finding nearby store locations for a product using maps, for example, on a mobile terminal, which should not unduly limit the scope of the present application herein. One of ordinary skill in the art would recognize many variations, alternatives, and modifications of the embodiments disclosed herein.

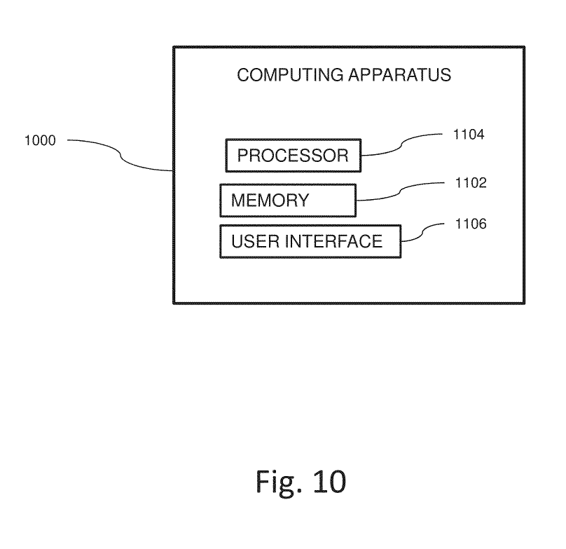

In at least one aspect of the disclosed embodiment, the systems and methods disclosed herein may be executed by one or more computers under the control of one or more programs stored on computer readable medium. FIG. 10 shows a block diagram of a computing apparatus 1000 that may be used to practice aspects of the disclosed embodiment. In at least one exemplary aspect, the mobile terminal, accelerator enabled devices, web enabled wireless devices, screens, web pages, views, overlays, displays, and buttons, and other disclosed devices and systems may be implemented using an instance or replica of the computing apparatus 1000 or may be combined or distributed among any number of instances or replicas of computing apparatus 1000.

The computing apparatus 1000 may include computer readable program code stored on at least one computer readable medium 1102 for carrying out and executing the processes and methods described herein. The computer readable medium 1102 may be a memory of the computing apparatus 1000. In alternate aspects, the computer readable program code may be stored in a memory external to, or remote from, the apparatus 1000. The memory may include magnetic media, semiconductor media, optical media, or any media which may be readable and executable by a computer. Computing apparatus 1000 may also include a processor 1104 for executing the computer readable program code stored on the at least one computer readable medium 1102. In at least one aspect, computing apparatus may include one or more input or output devices, generally referred to as a user interface 1106, for example, the user interface (UI) described above, which may operate to allow input to the computing apparatus 1000 or to provide output from the computing apparatus 1000, respectively. The user interface 1106 may include a device display, touch screen, buttons, and audio input and output.

The disclosed embodiments can be used for various purposes, including, though not limited to, enabling users to view advertisements, do shopping, browse product catalogues, etc.

It should be understood that while the disclosed embodiments have been described as implemented on mobile devices, the disclosed embodiments may be implemented on any suitable device including but not limited to non-portable terminals, portable terminals, smartphones, tablets, touch-sensitive devices, wired devices and wireless devices.

Modifications to the embodiments described in the foregoing are possible without departing from the scope of the embodiments as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

Those skilled in the art will realize that the above-recognized advantages and other advantages described herein are merely exemplary and are not meant to be a complete rendering of all of the advantages of the various aspects of the disclosed embodiment.

In the foregoing specification, specific aspects of the disclosed embodiment have been described. However, one of ordinary skill in the art appreciates that various modifications and changes can be made without departing from the scope of the disclosed embodiments. Accordingly, the specification and figures are to be regarded in an illustrative rather than a restrictive sense, and all such modifications are intended to be included within the scope of the disclosed embodiment. The benefits, advantages, solutions to problems, and any element(s) that may cause any benefit, advantage, or solution to occur or become more pronounced are not to be construed as a critical, or required.

1. A method of displaying information on a device comprising:
showing an indicator associated with a first content item on a display;
upon selecting the indicator, providing an overlay of information over the display; and
providing a scrolling function as part of the overlay for displaying additional information.

2. The method of claim 1 further comprising scrolling the overlay in a first direction for displaying information related to the first content item.

3. The method of claim 1 further comprising scrolling the overlay in a second direction for displaying additional content items.

4. The method of claim 1, wherein the overlay is organized as a two dimensional set of content regions.

5. The method of claim 1 further comprising providing a purchasing function in the overlay for purchasing content items.

6. The method of claim 1 further comprising providing a sharing function in the overlay for sharing interest in the first content item with other users.

7. The method of claim 1, further comprising changing an orientation of the overlay with changes in orientation of the device.

8. The method of claim 1, further comprising returning to the display of the first content item upon closing the overlay.

9. An apparatus for displaying information comprising:
a processor; and
a memory comprising program code, wherein the processor under control of the program code causes the apparatus to:
show at least a first content item on a display;
upon selection of the first content item, provide an overlay of information over the display; and
provide a scrolling function as part of the overlay for displaying additional information.

10. The apparatus of claim 9, wherein the processor under control of the program code further causes the apparatus to provide a scrolling function in a first direction in the overlay for displaying information related to the first content item.

11. The apparatus of claim 9, wherein the processor under control of the program code further causes the apparatus to provide a scrolling function in a second direction in the overlay for displaying additional content items.

12. The apparatus of claim 9, wherein the overlay is organized as a two dimensional set of content regions.

13. The apparatus of claim 9, wherein the processor under control of the program code further causes the apparatus to provide a purchasing function in the overlay for purchasing content items.

14. The apparatus of claim 9, wherein the processor under control of the program code further causes the apparatus to provide a sharing function in the overlay for sharing interest in the first content item with other users.

15. The apparatus of claim 9, wherein the processor under control of the program code further causes the apparatus to change an orientation of the overlay with changes in orientation of the apparatus.

16. The apparatus of claim 9, wherein the processor under control of the program code further causes the apparatus to return to the display of the first content item upon closing the overlay.

17. A non-transitory computer-readable medium having computer-executable components comprising instructions for:
showing at least a first content item on a display;
upon selecting the first content item, providing an overlay of information over the display; and
providing a scrolling function as part of the overlay for displaying additional information.

18. The non-transitory computer-readable medium of claim 1 further comprising computer-executable components comprising instructions for scrolling the overlay in a first direction for displaying information related to the first content item.

19. The non-transitory computer-readable medium of claim 1 further comprising computer-executable components comprising instructions for scrolling the overlay in a second direction for displaying additional content items.

20. The non-transitory computer-readable medium of claim 1 further comprising computer-executable components comprising instructions for providing a purchasing function in the overlay for purchasing content items.
